(19) United States
(12) Patent Application Publication
(10) Pub. No.: US 2018/0186058 A1
(43) Pub. Date: Jul. 5, 2018

(54) METHOD FOR PRODUCING 3-D OBJECTS

(71) Applicant: Covestro Deutschland AG, Leverkusen (DE)

(72) Inventors: Thomas BÜSGEN, Köln (DE); Dirk ACHTEN, Leverkusen (DE); Nicolas DEGIORGIO, Krefeld (DE); Roland WAGNER, Leverkusen (DE); Thomas MICHAELIS, Leverkusen (DE); Maria Elisabeth BEENEN-FUCHS, Köln (DE)

(21) Appl. No.: 15/740,487

(22) PCT Filed: Jun. 27, 2016
(86) PCT No.: PCT/EP2016/064821

§ 371 Date: Dec. 28, 2017

(30) Foreign Application Priority Data
Jun. 29, 2015 (EP) 15174313.5

(51) Int. Cl. B29C 51/02; B33Y 10/00; B33Y 80/00

(52) U.S. Cl. CPC B29C 51/02; B33Y 10/00; B29C 51/08; B29K 2995/0077; B33Y 80/00

(57) ABSTRACT

The invention relates to a method for producing a three-dimensional object, the outer surface of which comprises at least one surface segment that is created in that a surface segment in two-dimensional form is first produced on a flat base plate by means of an additive manufacturing method (layer-building shaping method), comprising the following steps: I) applying at least one curable polymer or curable reaction resin in flowable form as material webs to a flat base plate by means of a layer-building shaping method in order to create a first layer; II) applying a second layer to the first layer, which second layer is created by means of the same layer-building shaping method as in step I); III) optionally applying 1 to 198 further layers, which are created in accordance with step II), wherein in each case a new layer is applied to the previous layer; IV) curing the layers; V) detaching the cured surface segment from the flat base plate; and VI) shaping the cured surface segment into a three-dimensional object by means of deep-drawing or thermoforming; wherein at least one layer is created with a modulus of elasticity in the cured state of=500 MPa according to EN ISO 527-1 (last issue from April 1996, current ISO version from February 2012) by applying at least one curable polymer or curable reaction resin in flowable form as material webs to the particular substratum.

The invention relates in particular to a process for the manufacture of three-dimensional products made of polymers with a modulus of elasticity of ≥500 MPa, where two-dimensional plastics components which are produced by commonly used rapid-prototyping processes (additive manufacture) are then thermoformed or deep-drawn to give three-dimensional objects. These two-dimensional plastics components can by way of example be used in the production of cellphone shells, housings, e.g. of electrical items which have a 3D profile, packaging or furniture with surface structures, A, B or C column, a roof module or a dashboard of an automobile, a seat shell, a filter basket, medical products such as rigid corsets, orthoses, protectors, damping elements and lightweight structures with framework structure, etc.

Components constructed layer-by-layer, and processes for production of these, are known from additives manufacturing or generative manufacturing processes (also called rapid prototyping, rapid manufacturing, or rapid tooling). Examples of these processes are selective laser sintering and three-dimensional printing, for example as described in WO 00/26026, DE 10 2004 014 806, DE 102007009277, WO/2014/015037, WO 2014/100462 or EP 293 00 09.

Other generative processes and devices for the production of 3-dimensional components are known by way of example from EP 0429 196 A2, DE 92 18 423 U1, DE 195 15 165 C2 or DE 101 27 383.

Examples of processes known for the production of rigid, three-dimensional products are injection-molding processes, deep-draw and thermoforming of flat foils, and blow molding of parisons and milling from blocks.

It is an object of the invention to overcome the disadvantages of the prior art at least to some extent.

Another object of the invention is to provide a novel, faster and simplified process for the production of three-dimensional objects, e.g. objects with large surface area, high stability and low thickness, an example being a corset.

### DETAILED DESCRIPTION

The invention is based on the discovery that by use of topological methods it is possible to transform many components with large surface area and with thin external walls mathematically into a coherent “two-dimensional” form. The topology of a three-dimensional object can easily be produced via molding of the two-dimensional form with respectively individually appropriately designed structure.

A first aspect provides a process of the invention for the production of a three-dimensional object, the external area of which comprises at least one area section which is produced in that an area section in two-dimensional form is first produced by means of an additive manufacturing process (layer-by-layer shaping process) on a flat base plate, comprising the following steps:
I) application of at least one hardenable polymer or hardenable reactive resin in flowable form in the form of lines of material onto a flat base plate by means of a layer-by-layer shaping process for the production of a first layer;
II) application of a second layer onto the first layer produced by means of a layer-by-layer shaping process, preferably by means of the layer-by-layer shaping process as in step I);
III) optionally application of from 1 to 198 further layers produced as in step II), where respectively a new layer is applied onto the respective preceding layer;
IV) hardening of the layers;
V) separation of the hardened area section from the flat base plate; and
VI) molding of the hardened area section to give a three-dimensional object by means of deep-draw or thermoforming;
   where at least one layer is produced via application of at least one hardenable polymer or hardenable reactive resin with a modulus of elasticity in the cured state of ≥500 MPa in accordance with EN ISO 527-1 (latest issue dated April 1996, current ISO version of February 2012) in flowable form in the form of lines of material on the respective substrate.

An embodiment provides a process of the invention for the production of a three-dimensional object, the external area of which comprises at least one area section which is produced in that an area section in two-dimensional form is first produced by means of an additive manufacturing process (layer-by-layer shaping process) on a flat base plate (5), comprising the following steps:
I) application of at least one hardenable polymer or hardenable reactive resin with respectively a modulus of elasticity in the cured state of ≥500 MPa in accordance with EN ISO 527-1 (latest issue dated April 1996, current ISO version of February 2012) in flowable form in the form of lines of material onto a flat base plate by means of a layer-by-layer shaping process for the production of a first layer;
II) application of a second layer onto the first layer produced by means of a layer-by-layer shaping process, preferably by means of the layer-by-layer shaping process as in step I);
III) optionally application of from 1 to 198 further layers produced as in step II), where respectively a new layer is applied onto the respective preceding layer;
IV) hardening of the layers;
V) separation of the hardened area section from the flat base plate; and
VI) molding of the hardened area section to give a three-dimensional object by means of deep-draw or thermoforming.

A second aspect provides a process of the invention for the production of a three-dimensional object, the external area of which comprises at least one area section which is produced in that an area section in two-dimensional form is first produced by means of an additive manufacturing process (layer-by-layer shaping process) on a flat base plate, comprising the following steps:
i) application of at least one hardenable polymer or hardenable reactive resin with respectively a modulus of elasticity in the cured state of ≥500 MPa in accordance with EN ISO 527-1 (latest issue dated April 1996, current ISO version of February 2012) in flowable form as lines of material onto a flat base plate, by means of a layer-by-layer shaping process for the production of a layer, where the layer provides a coherent area with or without cutouts (for example in the shape of a honeycomb);
ii) hardening of the layer;
iii) separation of the hardened area section from the flat base plate; and
iv) molding of the hardened area section to give a three-dimensional object by means of deep-draw or thermoforming.

A preferred embodiment of the two aspects and their preferred embodiments provide a process of the invention where the layer-by-layer shaping process is melt layering (fused filament fabrication (FFF)), inkjet printing or photopolymer jetting.

Another preferred embodiment of the first aspect and its preferred embodiments provides a process where the layer-by-layer shaping process in step I) is melt layering (fused filament fabrication (FFF)), inkjet printing or photopolymer jetting.

Another preferred embodiment of the second aspect and its preferred embodiments provide a process where the layer-by-layer shaping process in step i) is melt layering (fused filament fabrication (FFF)), inkjet printing or photopolymer jetting.

Another preferred embodiment of the first aspect and its preferred embodiments provides a process where the layer-by-layer shaping process in step I) and II) and III) is respectively the same and is selected from the group consisting of melt layering (fused filament fabrication (FFF)), inkjet printing and photopolymer jetting.

Another preferred embodiment of the two aspects and their preferred embodiments provides a process where the discharge temperature of the substance mixtures from the nozzle in the steps I) to II) is in the range from 80° C. to 420° C.

Another preferred embodiment of the two aspects and their preferred embodiments provides a process where the base plate has been heated and the heating temperature of the base plate is in the range from 20° C. to 250° C.

Another preferred embodiment of the two aspects and their preferred embodiments provides processes where a hardenable polymer or hardenable reactive resin with a modulus of elasticity in the cured state of ≥500 MPa is selected from a group consisting of thermoplastic polyurethane (TPU), polycarbonate (PC), polyamide (PA), polyethylene terephthalate (PET), polybutylene terephthalate (PBT), cycloolefinic copolyester (COC), polyetheretherketone (PEEK), polyetheramideketone (PEAK), polyetherimide (PEI) (e.g. Ultem), polyimide (PI), polypropylene (PP) and polyethylene (PE), acrylonitrile-butadiene-styrene (ABS), polylactate (PLA), polymethyl methacrylate (PMMA), polystyrene (PS), polyvinyl chloride (PVC), polyoxymethylene (POM), polyacrylonitrile (PAN), polyacrylate, and celluloid preferably selected from a group consisting of TPU, PA, PEI, and PC, particularly preferably from a group selected from TPU and PC.

Another preferred embodiment of the two aspects and their preferred embodiments provides a process where the same hardenable polymer or hardenable reactive resin is used in all of the layers.

Another preferred embodiment of the first aspect and its preferred embodiments provides a process where at least one layer comprises another hardenable polymer or hardenable reactive resin.

Another preferred embodiment of the two aspects and their preferred embodiments provides processes where a hardenable polymer or hardenable reactive resin with respectively a modulus of elasticity in the cured state of ≥500 MPa is used in all of the layers.

Another preferred embodiment of the first aspect and its preferred embodiments provides processes where a hardenable polymer or hardenable reactive resin with respectively a modulus of elasticity in the cured state of <500 MPa is used in at least one layer.

Another preferred embodiment of the first aspect and its preferred embodiments provides processes where a hardenable polymer or hardenable reactive resin with respectively a modulus of elasticity in the cured state of <500 MPa is used in the first layer.

Another preferred embodiment of the first aspect and its preferred embodiments provides processes where a hardenable polymer or hardenable reactive resin with respectively a modulus of elasticity in the cured state of <500 MPa is used in the final layer.

Another preferred embodiment of the two aspects and their preferred embodiments provides processes where at least one hardenable polymer or hardenable reactive resin is used for the application of a layer in the form of a flowable and hardenable substance mixture.

Another preferred embodiment of the two aspects and their preferred embodiments provides processes where at least one hardenable polymer or hardenable reactive resin is used for the application of a layer in the form of at least two different flowable and hardenable substance mixtures.

Another preferred embodiment of the two aspects and their preferred embodiments provides processes where the hardening is achieved via cooling of thermoplastics, via low- or high-temperature polymerization, via polyaddition, polycondensation, addition or condensation, or via polymerization initiated by electromagnetic radiation.

Another preferred embodiment of the two aspects and their preferred embodiments provides processes where the hardening is achieved via a UV or IR light source placed immediately downstream of an injection nozzle (3).

Another preferred embodiment of the two aspects and their preferred embodiments provides processes where the three-dimensional object is a cellphone shell, a housing, e.g. of an electrical item, where said item has a 3D profile, packaging or an item of furniture with surface structures, an A, B or C column, a roof module or a dashboard of an automobile, a seat shell, a filter basket, a medical product such as a rigid corset or an orthosis, a protector, a damping element or a lightweight structure with framework structure.

A preferred embodiment of the first aspect and its preferred embodiments provides a process where a plurality of the individual lines of material are deposited in lateral direction or in the direction of application of the lines of material of the first layer with different thickness.

Another preferred embodiment of the two aspects and their preferred embodiments provides a process where at least one hardenable polymer or hardenable reactive resin is used for the application of a layer in the form of a flowable and hardenable substance mixture or where at least one hardenable polymer or hardenable reactive resin is used for the application of a layer in the form of at least two different flowable and hardenable substance mixture(s), where the substance mixtures comprise at least one filler selected from the group consisting of reinforcing fibers selected from polyamide fibers, glass fibers, carbon fibers or aramid fibers, or comprise reinforcing particles selected from inorganic or ceramic nano powders, metal powders or plastics powders or carbon black, and comprise organic and inorganic pigments.

Another preferred embodiment of the first aspect or of one of its other preferred embodiments provides a process where a line of material of a layer has only partially hardened when lines of material of a new layer are applied onto said layer, and the final hardening takes place together with the hardening of the line(s) of material deposited thereover.

Another aspect provides a process for the production of a protector appropriately designed for a user comprising the steps of:
a) determination of the relevant body-region-geometry data of the user;
b) calculation to convert the 3D-body-geometry data for the production of an area section in accordance with steps I) to V) or i) to iii) in accordance with a process of aspect one or two;
c) manufacture of a three-dimensional object in a process as claimed in any of claims 1 to 13, where step VI) or, respectively, step iv), the three-dimensional shaping, takes place via deep-draw or thermoforming in accordance with the body-region-geometry data of the user from step a).

The expressions body-region-geometry data and 3D-body-geometry data are used synonymously.

Another aspect provides a protector obtainable by a process of the invention.

The indefinite article “a/an” generally means “at least one”, i.e. “one or more”. The person skilled in the art will understand that in particular situations the meaning must be “one”, i.e. “1” and, respectively, that in an embodiment the indefinite article “a/an” also concomitantly comprises “one” (1).

All of the preferred embodiments described herein for a process of the invention or a product produced by a process of the invention can be combined with one another, as long as they do not contravene laws of nature.

### 3D Printing Processes

The expression “additive manufacture” is known to the person skilled in the art and is the generic expression for various processes for the rapid production of sample components on the basis of design data.

The expression “layer-by-layer shaping processes using flowable/flowable and hardenable substance mixtures” as used herein preferably refers to FFF, but can also refer to any other known 3D printing processes using flowable and hardenable substance mixtures, e.g. photopolymer jetting (http://www.custompartnet.com/wu/jetted-photopolymer; as at Apr. 8, 2015) or inkjet printing processes (http://www.custompartnet.com/wu/ink-jet-printing; as at Apr. 8, 2015).

The expression “fused filament fabrication” (FFF; melt layering, also sometimes called plastic jet printing (PJP)) as used herein means a manufacturing process which derives from the additive manufacturing sector and which can construct a workpiece layer-by-layer from a fusible plastic. FIG. 1 is a diagram of a setup for a FFF process. The plastic can be used with or without further additions such as fibers. Machines for FFF are classed as 3D printers. This process uses heating to liquefy a plastics or wax material in the form of wire. The material solidifies when it is finally cooled. The material is applied by extrusion, using a heated nozzle which can be moved freely in relation to a manufacturing plane. Possibilities here are either that the manufacturing plane is fixed, the nozzle being freely movable, or that a nozzle is fixed and a substrate table (with a manufacturing plane) can be moved, or that both elements, nozzle and manufacturing plane, can be moved. The velocity at which the substrate and nozzle can be moved in relation to one another is preferably in the range from 1 to 60 mm/s. The layer thickness is, as required by each application, in the range from 0.025 to 1.25 mm; the discharge diameter of the stream of material (nozzle outlet diameter) from the nozzle is typically at least 0.05 mm. The individual layers in layer-by-layer model production thus bond to give a complex part. A product is usually constructed in that an operating plane is repeatedly traversed line-by-line (formation of a layer), and then the operating plane is displaced upward “to form a stack” (formation of at least one further layer on the first layer), so that a molding is produced layer-by-layer.

The design of the nozzle here is preferably such that quantities of material can be dispensed either continuously or in droplet form. It is preferable that the quantities of material are dispensed in droplet form.

It is preferable that in the 3D printing process in the present process of the invention the nozzle is over the flat base plate (when the first layer is applied) or over previously applied layers at a distance corresponding to from 0.3 to 1 times the diameter of the material filament to be applied (nozzle outlet diameter), preferably from 0.3 to 0.9 times, for example from 0.3 to 0.8 times, from 0.4 to 0.8 times or from 0.5 times to 0.8 times. This correlation between distance of the nozzle from the substrate (substrate being either the flat base plate or a previously applied layer) and nozzle outlet diameter ensures that the material is forced on to the substrate with a certain applied pressure and better adhesion is thus produced between the layers of the resultant area section.

The substance mixtures used in the process of the invention are heated, shortly upstream of the nozzle or in the nozzle, to at least 75° C., and thus rendered flowable. The person skilled in the art is aware of the temperature ranges required to render known amorphous polymers/thermoplastics flowable. The temperature to which the liquefied substance mixtures are heated, this also being the discharge temperature of the substance mixtures from the nozzle, is in the range from 80° C. to 420° C., preferably from 120° C. to 400° C. (for example from 160° C. to 400° C.), more preferably in the range from 180° C. to 360° C.

In a process of the invention, a liquefied substance mixture is applied to the flat base plate through the nozzle in the form of lines of material for the production of a first layer, which consists of individual lines of material running parallel to one another; or consists of a coherent area made of lines of material bonded to one another, or consists of geometric figures formed by lines of material in honeycomb form or in another form. A line of material here can consist either of a continuous filament of material or of a plurality of filaments of material (e.g. individual droplets) which are applied alongside one another on the operating plane in a manner such that they flow into one another and thus form a continuous line of material. The viscosity of the substance mixture here after it leaves the nozzle in the form of line of material is sufficiently high to prevent uncontrolled flow of the resultant line.

As already described elsewhere, it is preferable that the line of material is applied in the form of droplets to the base plate or to a layer previously applied. Processes particularly suitable for the application of the polymer or reactive resin are jetted photopolymer and inkjet printing. The distance between adjacent droplets deposited here can be sufficiently small to permit formation of a coherent structure therefrom, an example being a geometric figure taking the form of a honeycomb or taking another form.

The person skilled in the art is aware of the viscosities/line diameters required in a process such as FFF, jetted photopolymer or inkjet printing.

By use of the ratio of distance between nozzle and substrate to filament diameter (proportional to the nozzle outlet diameter and velocity of the material) it is possible, through flattening (and thus broadening) of the stream of material discharged from the nozzle (a continuous filament of material or a plurality of filaments of material discharged in succession from the nozzle which then coalesce), to produce, through the application of the lines of material, either a coherent area or lines of material separated from one another by uncovered areas. If the first layer consists of lines of material which are not in lateral contact with each other, and if in the following step a second layer is applied onto the first layer, there must be points of contact (e.g. points of intersection) or areas of contact between the two areas in order to ensure that the two layers adhere to one another. In this case, in a process of the invention, the area covered by a first layer is defined via the second layer applied onto the first layer. In a case where a first layer has been applied in the form of lines of material parallel to one another, and a second layer has been applied to the first layer, either the value of the angle of the direction of application (quantitative value associated with the direction of application) of the lines of material of the second layer is ≠0°, based on the direction of application of the lines of material of the first layer (thus permitting formation of pores by the two layers) or the direction of application of the lines of material of the second layer is the same as the direction of application of the lines of material of the first layer, but the lines of material of the second layer are displaced by about half of the distance, preferably half of the distance, between the centers of the lines of material of adjacent lines of material of the first layer. Each line of the second layer here must have a width at least sufficient to bring about contact between said line and the two lines of the first layer that are respectively situated under said line. The displacement of the lines of material ensures, through the bonding of the two layers to one another, continuous bonding (no formation of pores).

A preferred embodiment of the present invention provides a process and, respectively, a three-dimensional object produced by a process of the invention, where at least two layers together form pores, where the size of the pores formed by these at least two layers is from 0.3 times to 1000 times the maximal line thickness of two layers forming the pore. In a preferred embodiment, the size of a pore is from 0.3 times to 5 times the maximal line thickness of two layers forming the pore.

By way of example, the distance between the nozzle, for example in an FFF process, and the substrate (flat base plate, interlay or previously printed layer), and the distance of the lines of material from one another during the formation of a (new) layer, can be selected in a process of the invention in such a way that no coherent area is formed during the formation of a (new) layer, but instead all of the layers of the area section are composed of parallel lines of material. The angle of the direction of application of the lines of material forming a layer here is ≠0° for two successive layers, based on the direction of application of the first of the two layers. It is preferable that the angle of the direction of application in the case of at least two successive layers is in the range from 30° to 150°, for example in the range from 45° to 135° or in the range from 60° to 120° or in the range from 85° to 95° or 90°. The person skilled in the art will understand that variations of up to ±5° can occur in the direction of application of the lines of material of a second layer onto a first layer because, by virtue of the mutually parallel lines of material of the substrate layer, the surface of the substrate for the second layer naturally exhibits local unevenness.

### Flat Base Plate

Flat base plates for additive manufacturing processes are known to the person skilled in the art. A flat base plate can be produced by a conventional or generative technique; by way of example, a base plate can be milled so that it has the advantages of accurate dimensions and shape, and also very good surface quality. There are many different materials available for milling, an example being ureol, wood or aluminum. For a particular geometry it can be advisable to produce the base generatively, for example by means of laser sintering.

A flat base plate serves for the shaping of the surface of the area section produced in a process of the invention. Accordingly, a first layer can be applied in a process of the invention directly onto a flat base plate; alternatively, there can be an interlay present, for example a textile or a foil, which transfers the shape of the surface of the flat base plate to the first layer of a process of the invention, where the first layer is applied on said interlay and the lines of material of the first layer bond to said interlay, and therefore this interlay becomes part of the area section and thus also part of the three-dimensional object.

The surface of the flat base plate preferably consists of glass, carbon, polypropylene, or stainless steel, or of a surface coated with Teflon or with polyimide, etc.; alternatively, said surface is specifically provided with an adherent primer layer which promotes adhesion of the objects to be printed on the surface, thus minimizing distortion of the desired objects to be printed. The adherent layer here is typically a low-melting-point compound which may be predissolved in a suitable solvent. The person skilled in the art is aware of a very wide variety of adhesion promoters.

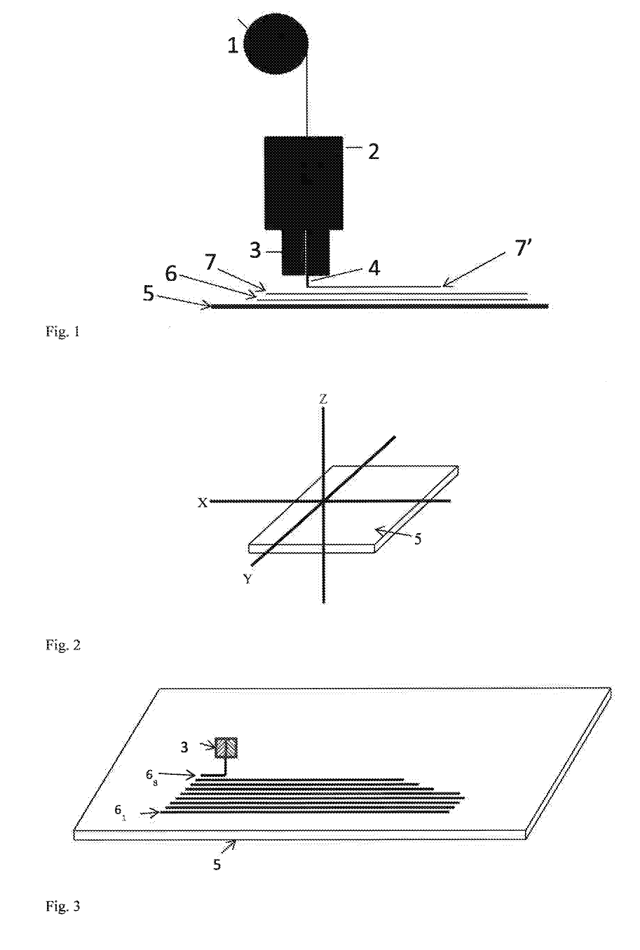

A “flat base plate” for the purposes of the present invention is a substrate which is in essence flat in the operating plane and on which the first layer of an area section is applied in a production process of the invention. “Essentially flat” means that a substrate is fixed in an XY-plane of a Cartesian coordinate system with three axes X, Y and Z (Z then being 0), and exhibits no deviation on the Z-axis, or exhibits only slight deviation thereon, caused by material (see, for example, FIG. 2). Deviations in Z-direction for a plane defined in XY-direction are preferably at most 3 mm, more preferably at most 1 mm, but it is still more preferable that the deviations in Z-direction of the surface are at most twice the maximal layer-application thickness of a first layer (but at most 3 mm, preferably at most 1 mm); it is particularly preferable that the deviations in Z-direction of the surface are smaller than the maximal layer-application thickness of a first layer, where the size of the flat base plate in its orthogonal dimensions in an imaginary XY-plane is respectively greater at least by a factor of 5, preferably by a factor of 10, with preference by a factor of 50, with more preference by a factor of 100, than the maximal deviation in the Z-plane. By way of example, the diameter of a round, flat base plate with a height difference of 2 mm is at least 1 cm, at least 2 cm, at least 10 cm or at least 20 cm; if a flat base plate is square, the length of the edges forming the base plate is respectively at least 1 cm, 2 cm, 10 cm or 20 cm.

The shape of a flat base plate is irrelevant, as long as the base plate has a flat area which serves as substrate for a first layer of an area section, and as long as said base plate is, in all of its X- and Y-directions, larger than or as large as the area of the first layer of a two-dimensional area section of the present invention. The shape of the base plate can be symmetrical, e.g. round, rectangular, square, etc., or asymmetrical.

In a preferred embodiment, the flat base plate can be heated in order to delay premature hardening of the material via temperature-related solidification of the first layer. The temperature to which the base plate is heated is preferably in the range from 20° C. to 250° C., for example from 30° C. to 250° C., or for example in the range from 40° C. to 200° C., for example from 60° C. to 200° C. or from 60° C. to 150° C. However, the temperature to which the flat base plate is heated should not be above the nozzle-discharge temperature used in a process of the invention for a to provide flowability to the flowable and hardenable substance mixture. It is preferable that the heating temperature is at least 10° C. below the nozzle-discharge temperature.

Heating of the flat base plate is preferably continued at least until, after conclusion of the application of the first layer of the area section, at least one second layer has been applied onto the first layer.

### Substance Mixtures

A hardenable polymer or hardenable reactive resin for the purposes of the present invention can be used alone or in the form of “flowable and hardenable substance mixtures” in a process of the invention. The expression “flowable and hardenable substance mixtures” accordingly refers to a substance mixture comprising at least one hardenable polymer or at least one hardenable reactive resin—preferably a thermoplastic—and at least one additional substance, for example fibers, UV hardeners, peroxides, diazo compounds, sulfur, stabilizers, inorganic fillers, plasticizers, flame retardants and antioxidants. In particular in the case of reactive resins, mixtures of two or more reactive resins can have been mixed in advance, or are mixed on the substrate. In the latter case it is possible by way of example that application takes place from different nozzles. The flowable and hardenable substance mixtures can differ in their nature, but must, under the conditions of the process of the invention, be low- or high-viscosity extrudable plastics compositions or liquid printable plastics compositions. These can be thermoplastics, silicones, unvulcanized rubber or else hardenable reactive resins (preferred product of hardened reactive resins being a thermoplastic).

Thermoplastics can by way of example be thermoplastic polyurethane (TPU), polycarbonate (PC), polyamide (PA), polyethylene terephthalate (PET), polybutylene terephthalate (PBT), cycloolefinic copolyester (COC), polyetheretherketone (PEEK), polyetheramideketone (PEAK), polyetherimide (PEI) (e.g. Ultem), polyimide (PI), polypropylene (PP) and polyethylene (PE), acrylonitrile-butadiene-styrene (ABS), polylactate (PLA), polymethyl methacrylate (PMMA), polystyrene (PS), polyvinyl chloride (PVC), polyoxymethylene (POM), polyacrylonitrile (PAN), polyacrylate, and celluloid preferably selected from a group consisting of TPU, PA, PEI, and PC, particularly preferably from a group selected from TPU and PC.

The flowable and hardenable substance mixtures and, respectively, hardenable polymers or hardenable reactive resins in a process of the invention can be polymers and/or polymerizable oligomers and, respectively, monomers with or without additional substances, e.g. polyamide, polyethylene terephthalate (PET), polybutylene terephthalate (PBT), Kevlar fibers, glass fibers, aramid fibers or carbon fibers, rayon, cellulose acetate, and/or commonly used natural fibers (e.g. flax, hemp, coir, etc.). The substance mixtures can also comprise, alongside or instead of fibers, reinforcing particles, in particular selected from inorganic or ceramic nano powders, metal powders or plastics powders, for example made of SiO₂ or Al₂O₃, AlOH₃, carbon black, TiO₂ or CaCO₃. Substance mixtures can moreover comprise by way of example peroxides, diazo compounds and/or sulfur.

Preferred hardenable polymers or hardenable reactive resins or flowable and hardenable substance mixtures comprising a hardenable polymer or hardenable reactive resin, where these are used in a process of the invention, consist of/comprise thermoplastic polymers or reactive resins which react to give a thermoplastic.

Preference is in particular given to substance mixtures in a process of the invention comprising/consisting of thermoplastic polyurethane (TPU), polycarbonate (PC), polyamide (PA), polyethylene terephthalate (PET), polybutylene terephthalate (PBT), cycloolefinic copolyester (COC), polyetheretherketone (PEEK), polyetheramideketone (PEAK), polyetherimide (PEI) (e.g. Ultem), polyimide (PI), polypropylene (PP) and polyethylene (PE), acrylonitrile-butadiene-styrene (ABS), polylactate (PLA), polymethyl methacrylate (PMMA), polystyrene (PS), polyvinyl chloride (PVC), polyoxymethylene (POM), polyacrylonitrile (PAN), polyacrylate, and celluloid. Particular preference is given to substance mixtures comprising/consisting of TPU, PA, PEI, or PC; very particular preference is given to substance mixtures comprising/consisting of TPU or PC.

In a particularly preferred embodiment, a process of the invention uses, as flowable and hardenable substance mixtures or hardenable polymers, TPU, PC, PA, PVC, PET, PBT, COC, PEEK, PEAK, PEI, PP, PE, PAN, ABS, PLA, PMMA, PS PVC, POM, PAN, polyacrylate or celluloid (preferably TPU, PC, PA or PEI, particularly preferably TPU or PC) in the form of filament, pellets or powder. In another preferred embodiment, these flowable and hardenable substance mixtures made of TPU, PC, PA, PVC, PET, PBT, COC, PEEK, PEAK, PEI, PP, PE, PAN, ABS, PLA, PMMA, PS PVC, POM, PAN, polyacrylate or celluloid (preferably TPU, PC, PA or PEI, particularly preferably TPU or PC) additionally comprise fibers (e.g. glass fibers) and/or reinforcing particles, possible fibers being both short fibers <2 mm and long fibers >2 mm. It is also possible to use “continuous-filament fibers” which continue throughout the entire length of an applied line of material. The presence of fibers during the extrusion of the flowable and hardenable substance mixture in a process of the invention leads to anisotropic reinforcement of the resultant lines made of the flowable and hardenable substance mixture, without any significant associated effect on the ability of the lines of material to bend longitudinally. Quantities of fiber preferably added are up to 40% by weight, based on the extruded plastic. Suitable fibers can by way of example be glass filaments, quartz filaments, carbon fibers or other inorganic fibers, or synthetic fibers with a modulus of elasticity ≥1 GPa, for example Kevlar fibers or aramid fibers. The modulus of elasticity typically increases with addition of the fibers by a factor of >1.5, particularly preferably >2.

In another preferred embodiment, a process of the invention uses hardenable reactive resins or flowable and hardenable substance mixtures comprising hardenable reactive resins which by way of example undergo UV-activated hardening or enter into a chemical reaction with one another or with air. Examples here are two-component polyurethanes (2C PU), two-component epoxides (2C EP), air-curing or free-radical-curing unsaturated polyesters, and also any of the UV-curing reactive resins known to the person skilled in the art based on, for example, vinyl compounds and on acrylic compounds, and also on combinations of various curing mechanisms.

Modulus of elasticity data relating to polymers and reactive resins as used herein refer unless explicitly otherwise stated to the modulus of elasticity of the polymers and, respectively, reactive resins in the crystalline (hardened) state, and not to the modulus of elasticity of a polymer or reactive resin under the conditions of extrusion of a flowable and hardenable substance mixture.

Modulus of elasticity is determined here in accordance with EN ISO 527-1 (latest issue dated April 1996, current ISO version of February 2012).

In another preferred embodiment, the modulus of elasticity of a polymer, preferably of a thermoplastic polymer, for the production of a first layer in a process of the invention where appropriate in a flowable and hardenable substance mixture (for example TPU, PC, PA or PEI, in particular TPU or PC, optionally respectively with admixed fibers) is greater than or equal to 500 megapascals (MPa), preferably ≥1 GPa (gigapascal); more preferably in the range from 500 MPa to 50 GPa (e.g. in the range from 1 GPa to 50 GPa), still more preferably in the range from 500 MPa to 30 GPa (e.g. in the range from 1 GPa to 30 GPa), in the range from 500 MPa to 20 GPa or in the range from 1 GPa to 10 GPa. The modulus of elasticity (under the conditions of the extrusion process) of these flowable and hardenable substance mixtures can by way of example be higher because of the use of fibers, but the modulus of elasticity of the polymer used here is always at least 500 MPa. Preference is given to a modulus of elasticity not greater than 20 GPa in order to avoid problems in achieving extrusion through a nozzle or passing through an inject head.

In a preferred embodiment, the modulus of elasticity of another plastic for the production of at least one further layer in a process of the invention where appropriate in a flowable and hardenable substance mixture (e.g. TPU, PA, PEI, or PC, preferably TPU or PC, optionally respectively admixed with fibers) is at least 500 megapascals (MPa), preferably 800 MPa, more preferably 1 GPa, still more preferably 1.5 GPa, for example in the range from 500 MPa to 20 GPa or in the range from 800 MPa to 10 GPa. The modulus of elasticity (under the conditions of the extrusion process) of these flowable and hardenable substance mixtures can by way of example be higher than the modulus of elasticity of the plastic because of the use of fibers, but the modulus of elasticity of the polymer used here is likewise at least 500 MPa.

In another preferred embodiment, the modulus of elasticity of all of the plastics for the production of a layer in a process of the invention where appropriate in a flowable and hardenable substance mixture (e.g. TPU, PC, PA, PVC, PET, PBT, COC, PEEK, PEAK, PEI, PP, or PE, PAN, ABS, PLA, PMMA, PS PVC, POM, PAN, polyacrylate or celluloid (preferably TPU, PC, PA or PEI, particularly preferably TPU or PC, optionally respectively admixed with fibers) is at least 500 megapascals (MPa), preferably 800 MPa, more preferably 1.5 GPa, for example in the range from 500 MPa to 20 GPa or in the range from 800 MPa to 10 GPa. The modulus of elasticity (under the conditions of the extrusion process) of these flowable and hardenable substance mixtures can by way of example be higher because of the use of fibers, but the modulus of elasticity of the polymer used here is likewise at least 500 MPa.

In another preferred possible embodiment, one, two, three, four or five, or more than five—preferably but not necessarily coherent—layers on an area section and, respectively of a three-dimensional object were produced from hardenable polymers or hardenable reactive resins respectively with a modulus of elasticity less than 500 megapascals (MPa). The hardenable polymers or hardenable reactive resins with a modulus of elasticity less than 500 MPa can be used alone or in the form of substance mixtures comprising these hardenable polymers or hardenable reactive resins. The modulus of elasticity of the hardenable polymers or hardenable reactive resins used here can by way of example be less than 400 MPa, less than 250 MPa, preferably less than 200 MPa, more preferably less than 150 MPa, still more preferably less than 100 MPa, for example in the range from 1 to 100 MPa or in the range from 5 to 50 MPa. In a particularly preferred embodiment, these layers with a modulus of elasticity of less than 500 MPa consist of thermoplastics, e.g. polyurethane (PU), polyvinyl chloride (PVC), thermoplastic elastomers (TPE) such as TPO (thermoplastic elastomers based on olefin, mainly PP/EPDM, e.g. Santoprene (AES/Monsanto)), TPV (crosslinked thermoplastic elastomers based on olefin, mainly PP/EPDM, e.g. Sarlink (DSM), Forprene (SoFter)), TPU (thermoplastic elastomers based on urethane (thermoplastic polyurethanes), e.g. Desmopan, Texin, Utechllan (Bayer)), TPC (thermoplastic polyester elastomers/thermoplastic copolyesters, e.g. Keyflex (LG Chem)), TPS (styrene block copolymers (SBS, SEBS, SEPS, SEEPS and MBS), e.g. Styroflex (BASF), Septon (Kuraray), thermoplast (Kraiburg TPE) or Saxomer (Polyplast Compound Werk GmbH), preferably PE, PU or TPE (in particular TPU or TPV, optionally respectively admixed with fibers). The modulus of elasticity (under the conditions of the extrusion process) of these flowable and hardenable substance mixtures can by way of example be higher because of the use of fibers, but the modulus of elasticity of the polymer used here is respectively less than 500 MPa.

In another preferred embodiment, the modulus of elasticity of a polymer, preferably of a reactive resin for the production of a first layer in a process of the invention where appropriate in a flowable and hardenable substance mixture (e.g. 2C PU, 2C EP, moisture-curing PU systems, air-curing or free-radical-curing unsaturated polyesters or UV-curing reactive resins based on, for example, vinyl compounds and on acrylic compounds) is at least 500 megapascals (MPa), preferably 800 MPa, more preferably 1 GPa, still more preferably 1.5 GPa, for example in the range from 500 MPa to 20 GPa or in the range from 800 MPa to 10 GPa. The modulus of elasticity (under the conditions of the extrusion process) of these flowable and hardenable substance mixtures can by way of example be higher because of the use of fibers, but the modulus of elasticity of the polymer used here is at least 500 MPa.

In a preferred embodiment, the modulus of elasticity of at least one other plastic for the production of at least one further layer in a process of the invention where appropriate in a flowable and hardenable substance mixture (e.g. 2C PU, 2C epoxy, moisture-curing PU systems, air-curing or free-radical-curing unsaturated polyesters or UV-curing reactive resins based on, for example, vinyl compounds and on acrylic compounds) is at least 500 megapascals (MPa), preferably 800 MPa, more preferably 1 GPa, still more preferably 1.5 GPa, for example in the range from 500 MPa to 20 GPa or in the range from 800 MPa to 10 GPa. The modulus of elasticity (under the conditions of the extrusion process) of these flowable and hardenable substance mixtures can by way of example have been further increased by the use of fibers, but the modulus of elasticity of the polymers or reactive resins used in this substance mixture is respectively at least 500 MPa.

In another embodiment, the modulus of elasticity of another plastic for the production of at least one further layer in a flowable and hardenable substance mixture (e.g. TPU or PC, optionally respectively admixed with fibers) is more than 500 megapascals (MPa), e.g. more than 1 gigapascal (GPa), for example in the range from 1 GPa to 3 GPa, or in the range from 1 GPa to 2.5 GPa. The modulus of elasticity (under the conditions of the extrusion process) of these flowable and hardenable substance mixtures can by way of example however be still higher after cooling/hardening because of the use of fibers. The modulus of elasticity should, however, not be greater than 20 GPa, because otherwise it is very difficult to achieve extrusion through a nozzle or passage through an inkjet head. In a preferred embodiment, these layers made of polymers or of reactive resins with modulus of elasticity values above 500 MPa have a smaller areal extent than the area of the first layer; by way of example, the spread in terms of area formed by a second or subsequent layer applied in a process of the invention is in the range from 0.01 to 99%, for example from 0.1 to 95% or from 0.1 to 90% or from 0.1 to 80%, based on the area of the first layer.

### Layers

Production of each layer in an additive manufacturing process of the invention is achieved by depositing material line by line in the form of lines of material in accordance with geometric data.

The material in the form of lines of material is preferably applied in the form of droplets onto the base plate or onto one of the layers that may already be present on the base plate. For the purposes of the invention, droplet means any quantity of material of which the maximal dimension in each spatial direction is not more than 1 mm, preferably not more than 0.5 mm, or preferably not more than 0.1 mm. The average diameter of the droplets is preferably in the range from 0.01 to 1 mm, or preferably in the range from 0.05 to 0.7 mm, or preferably in the range from 0.1 to 0.5 mm. Average diameter in the invention means the average value calculated from the diameter of the droplet at the location with the greatest dimension and the diameter of the droplet at the location with the smallest dimension. The droplets here can be applied to the entire area of the base plate or of the previously applied layer, or merely to a portion of the area of the base plate or previously applied layer. The droplets can have a shape selected from the group consisting of circular, oval, polygonal and combinations of at least two of these. At least one line of material, preferably at least two lines of material, or preferably all of the lines of material, for the formation of the three-dimensional object, is/are preferably applied in the form of droplets to the base plate or to a layer previously applied.

If the viscosity and size of the droplets, and the distance between these, are appropriate, the droplets can coalesce to give lines of material which cover the entire area of the surface to be coated, for example base plate or previously applied layer. Alternatively, the distance between the droplets can be selected in such a way that lines of material separate from one another in the form of droplets cover only a portion of the base plate or previously applied layer. It is preferable that the portion of the base plate or of the previously applied layer covered by the line of material is in the range from 2 to 100%, or preferably from 10 to 100%, or preferably from 20 to 100%, or preferably from 50 to 100%, based on the total area of the base plate or on the total area of the previously applied layer. It is thus possible to produce three-dimensional objects in which individual layers can have contact with more than their two directly adjacent layers.

The volume of the droplets is preferably in the range from 1 pl to 500 μl, or preferably in the range from 5 pl to 400 μl, or preferably in the range from 10 pl to 300 μl. The length of the line of material preferably formed from droplets is preferably in the range from 0.1 mm to 100 m, or preferably in the range from 0.5 mm to 50 m, or preferably in the range from 1 mm to 10 m. The thickness of the line of material after application is preferably in the range from 1 μm to 1.25 mm, or preferably in the range from 5 μm to 0.9 mm.

An example of a process which can be used for the application of material in the form of lines of material, alongside the deposition processes such as inkjet that have been known for a long time is ARBURG Plastic Freeforming (APF) using the “freeformer” device from ARBURG GmbH+ Co KG, which uses 3D-CAD data to permit application of very small droplets onto the desired surface.

The processes of the invention provide that, for the production of at least one layer, a hardenable polymer or hardenable reactive resin with respectively a modulus of elasticity in the cured state of ≥500 MPa is applied in flowable form in the form of lines of material to a flat base plate or to a substrate. This means that at least 80% by weight, in particular at least 90% by weight, preferably at least 95% by weight and up to 100% by weight, of the layer produced consists of hardened polymers and/or reactive resins which in this state have a modulus of elasticity ≥500 MPa.

A preferred embodiment is directed to a process of the invention in which at least the first layer is produced in that a hardenable polymer or hardenable reactive resin with respectively a modulus of elasticity in the cured state of ≥500 MPa is applied in flowable form in the form of lines of material onto the respective substrate.

A preferred embodiment is directed to a process of the invention in which at least the second layer is produced in that a hardenable polymer or hardenable reactive resin with respectively a modulus of elasticity in the cured state of ≥500 MPa is applied in flowable form in the form of lines of material onto the respective substrate.

A preferred embodiment is directed to a process of the invention in which at least 5, more preferably at least 10, still more preferably at least 15, layers are produced in that a hardenable polymer or hardenable reactive resin with respectively a modulus of elasticity in the cured state of ≥500 MPa is applied in flowable form in the form of lines of material onto the respective substrate.

A preferred embodiment is directed to a process of the invention in which all of the layers are produced in that a hardenable polymer or hardenable reactive resin with respectively a modulus of elasticity in the cured state of ≥500 MPa is applied in flowable form in the form of lines of material onto the respective substrate.

Another preferred embodiment here is directed to a process of the invention in which the first and the final layer are produced in that a hardenable polymer or hardenable reactive resin with respectively a modulus of elasticity in the cured state of ≥500 MPa is applied in flowable form in the form of lines of material onto the respective substrate, and all of the layers between the first and the final layer are produced in that a hardenable polymer or hardenable reactive resin with respectively a modulus of elasticity in the cured state of ≥500 MPa is applied in flowable form in the form of lines of material onto the respective substrate.

Another preferred embodiment here is directed to a process of the invention in which the first 1 to 10 layers and the final 1 to 10 layers are produced in that a hardenable polymer or hardenable reactive resin with respectively a modulus of elasticity in the cured state of ≥500 MPa is applied in flowable form in the form of lines of material onto the respective substrate, and the layer(s) (preferably all of the layers) between the first 1 to 10 layers and the final 1 to 10 layers are produced in that a hardenable polymer or hardenable reactive resin with respectively a modulus of elasticity in the cured state of ≥500 MPa is applied in flowable form in the form of lines of material onto the respective substrate.

The layer thickness of a layer of a three-dimensional object produced by a process of the invention is preferably in the range from 0.025 mm to 1.25 mm, more preferably in the range from 0.1 mm to 0.9 mm.

The discharge diameter of the stream of material from the nozzle (proportional to the nozzle outlet diameter and the velocity of the material) in the process of the invention is preferably in the range from 0.025 mm to 1.4 mm. However, it is preferably at least 0.03 mm. It is preferably in the range from 0.03 mm to 1.3 mm, more preferably in the range from 0.15 to 1 mm. A smaller distance between nozzle and substrate (flat base plate, interlay, or previously applied layer(s)), based on the nozzle outlet diameter, leads to a smaller thickness (height) of a layer. The material is thus squeezed to give a strand with oval cross section. A non-restricting explanation is that a smaller distance between the nozzle and the substrate in relation to the discharge diameter of the stream of material leads to better adhesion of the new layer on the respective substrate.

It is preferable that the first layer in a process of the invention is produced from a polymer, more preferably a thermoplastic polymer, which has a modulus of elasticity of at least 500 megapascals (MPa), preferably 800 MPa, more preferably 1 GPa, still more preferably 1.5 GPa, for example a modulus of elasticity in the range from 500 MPa to 20 GPa or in the range from 800 MPa to 10 GPa.

In the present invention it is possible that different layers of an area section are produced from different substance mixtures or that all of the layers of an area section are produced from the same substance mixture. It is moreover also possible that a layer consists of different substance mixtures, but it is preferable that the hardenable polymer and, respectively, hardenable reactive resin in these different substance mixtures respectively is the same hardenable polymer and hardenable reactive resin (by way of example, a layer can consist of PU mixtures with various color pigments).

Different layers can have different shapes. The shape of the at least one area section is selected in accordance with the nature of the three-dimensional product to be produced, the external area of which comprises at least one area section produced by the process described herein. If the area section by way of example relates to cellphone shells, housings, e.g. of electrical items which have a 3D profile, packaging or furniture with surface structures, A, B or C column, a roof module or a dashboard of an automobile, a seat shell, a filter basket, medical products such as rigid corsets, orthoses, protectors, damping elements or lightweight structures with framework structure, the person skilled in the art will accordingly select, for the area section, an asymmetrical shape selected in such a way that after the area section has been thermoformed or deep-drawn to give a 3-dimensional object this already has the desired three-dimensional shape.

In a preferred embodiment, the extent of the first layer in the operating plane determines the greatest areal extent of the layers of the area section from which a three-dimensional object is molded.

In another preferred embodiment, in a process of the invention the first layer is, in terms of area, the largest layer in an area section, i.e. none of the other layers of an area section produced by the process described herein has a greater area than the first layer; it is particularly preferable that, when the XY operating plane is viewed orthogonally in a process of the invention, none of the other layers of an area section extends, in X- and/or Y-direction, outside of the area of the first layer on the flat base plate.

In another preferred embodiment, the first layer is molded on a flat base plate, and the absolute value of the height difference of the flat base plate here on an imaginary Z-axis in a superimposed orthogonal coordinate system, where the base plate is defined in the XY-plane (see FIG. 2), based on the area of the first layer applied onto the flat base plate, is at most 5%, preferably at most 3%, more preferably at most 1%, still more preferably at most 0.5%, particularly preferably at most 0.1%, and where the maximal orthogonal extents of the area section in the XY-pane are greater than the height difference on the relevant area of the flat base plate at least by a factor of 5, preferably at least by a factor of factor 10, more preferably at least by a factor of 25, still more preferably at least by a factor of 50, for example at least by a factor of 100.

As already explained, in a process for the purposes of the invention a layer is composed of individual lines of material which, in accordance with distance from one another and with the ratio between nozzle outlet diameter and distance between nozzle and substrate continue to take the form of individual line(s) in the layer in the hardened area section or coalesce to form a two-dimensional layer which can optionally have cutouts. As already mentioned, the lines of material can consist of regions of material applied in droplet form on the base plate or on a previously applied layer.

“Pores” for the purposes of the invention are formed by two layers where both layers have distances between the lines of material forming a layer and the angle of application of the two layers with respect to one another is ≠0°. “Cutouts” for the purposes of the present invention are areas which are within a layer and which are not covered with material of the layer and which arise as a result of lines of material which are sometimes spatially separate but which have at least 2 points of contact with one another, or as a result of a line of material which comes into contact with/intersects itself in the direction of application (e.g. circle) (e.g. hexagonal grid in FIG. 10). “Voids” for the purpose of the present invention are interruptions in a layer where areas of a plane are not in contact with one another and the distance between these areas of a layer is at least 5 thicknesses of a line of material.

If the lines of material are applied in the form of droplets it is possible, by varying the distance between the droplets, or by selecting the size of the droplets, for example their diameter, to generate a void, for example in the form of a pore, with no material in this layer. If no material is applied at the same location over a plurality of layers in the layer structure, it is possible to produce voids over a plurality of lines of material. The extent of the voids within the layer is preferably in the range from 0.01 to 1 mm, or preferably in the range from 0.05 to 0.7 mm, or preferably in the range from 0.1 to 0.5 mm. The extent of the voids perpendicularly to the layer is preferably in the range from 0.01 to 1 mm, or preferably in the range from 0.05 to 0.7 mm, or preferably in the range from 0.1 to 0.5 mm.

Said lines can not only be straight: they can also by way of example be applied in a serpentine pattern, for example parallel to one another on the respective substrate, or the direction of application can be changed.

A layer for the purposes of the present invention can consist of lines of material which have very substantially identical parallel distance from one another throughout and do not touch one another, and are bonded to one another only via contact with a layer situated thereunder or situated thereover. It is equally possible that the layer consists of a coherent area, an example being a two-dimensional layer with or without cutouts or voids. The coherent layer can moreover be composed of lines of material which do not run parallel to one another but instead where at least two lines of material come into contact with one another more than once and thus can form coherent, optionally geometrical figures, for example hexagons, or circular or asymmetrical pores. It is preferable that all of the lines of material of such a layer have more than 2, preferably more than 5, still more preferably more than 10, points of contact with adjacent lines of material.

A layer in a process of the invention is preferably characterized in that it is produced on the same substrate. It is also possible here for the purpose of the present invention that a layer consists of a plurality of areas which are not in contact with one another, or of lines of material which are applied in the invention onto a substrate, where the distance between the areas and/or lines of material during application is at least 5 thicknesses of a line of material, preferably at least 10, more preferably at least 20 (voids).

The substrate of a new layer to be applied in a process of the invention can by way of example be the flat base plate, an interlay or the layer most recently applied. In another embodiment of the present invention, the substrate for a, new layer to be applied in a process of the invention is not only the most recently applied layer but also onto more than one of the layers already applied (e.g. in the case of cutouts or voids on the layer most recently applied or a layer most recently applied that is smaller than the new layer and the previously applied layer). A possible embodiment is application of the first of the two layers of a full-surface pattern and/or inscription onto the second layer of the layers forming the honeycomb structure and the second layer of the first two layers consisting of parallel lines rotated through 90°. By virtue of the large separations (cutouts) in the third and fourth layer (the honeycomb pattern), the lines of material of the first of the two pattern/inscription layers are applied by a nozzle in a process of the invention both to the lines of material of the fourth layer that form the hexagons and in the cutouts of the honeycomb structure onto the lines of material of the second layer, which are displaced by 90° in relation to the lines of material of the first layer.

Accordingly, an embodiment of the present invention is directed to area sections and three-dimensional objects, and processes of the invention, resulting in these area sections and three-dimensional objects, where at least one layer is applied onto two or more previously applied layers. This is the case by way of example when a second layer which has been applied onto a first, lower, layer has distances between lines of material, voids or other geometric cutouts (e.g. hexagonal cutouts), and these are sufficiently large that not only do the newly applied lines of material of a third layer rest on the material of the second layer but, by virtue of the rheology in the flowable state, and because of the distances between the lines of material of the second layer or the voids in the second layer, the material is concomitantly deposited directly onto the material of the first layer. However, in this case the layer can still be defined via its mutually parallel lines of material or coherent area or coherent lines of material which form asymmetrical or geometric figures such as honeycombs.

In particular when at least one layer is formed via application of a line of material in the form of droplets, contact of a previously applied layer with a subsequently applied layer can be rendered possible, whereas this would not be possible in the case of full-surface coating of the base plate or of the previous layer.

It is accordingly possible to change the thickness profile of an individual line of material in longitudinal direction during extrusion. In particular, it is important here that it is also possible to achieve a minimal thickness of 0 mm (no extrusion at this location). It is thus possible to interrupt deposition of material over some of, or all of, the width of a line of material and achieve cutouts or voids in a layer of an area section.

An advantageous procedure for the production of voids (vacant regions) in the component is to close the nozzle aperture during jetting or extrusion in the appropriate cutout regions, or to interrupt the flow of material through the nozzle at this location, and reopen after said regions have been traversed, or to stop forward movement of the material in front of the nozzle and recommence same after said regions have been traversed.

For coherence of the lines of material within a layer, or between layers, or interlaminar strength of the finished component, it is important to maximize coherent bonding between the layers of material. To this end it is in particular intended that the underlying line of material, or geometric shapes such as honeycomb structures, cure(s) only partially during the application of a further layer, and that final curing is delayed and takes place together with the curing of the lines of material deposited thereover. This is rendered possible by way of example in that the hardening of the recently deposited material is begun at a rate such that reactive components remain present during the next material-deposition cycle. Recrystallization of amorphous polymers of the recently deposited line of material, or of the deposited material (in the case of continuous layers or, for example, honeycomb structures) here must be controlled sufficiently at least to retain dimensional stability, i.e. to prevent uncontrolled flow. The hardening rate is preferably controlled in such a way that final curing takes place together with the curing of the line of material deposited immediately thereover.

As already mentioned it is also possible to use different compositions of material within a layer, and even within a line of material. This is possible by way of example via multiple-head extrusion, and allows, for example, application of different materials in succession in the same layer (an example being different colors within a layer).

However, it is preferable that each layer consists of the same polymer or reactive resin, irrespective of any other additional substances added to this polymer or reactive resin. Accordingly, a preferred embodiment is directed to a process of the invention where each layer of an area section consists of lines of material with the same polymer or reactive resin. Another embodiment is directed to a process of the invention where each layer of an area section consists of lines of material with the same polymer or reactive resin.

### Area Section

A “two-dimensional area section” for use in the production of a three-dimensional article for the purposes of the present invention refers to a product where—after production by a generative production process and before molding to give a three-dimensional object—the extent of the individual layers in the direction of X-axis and Y-axis (ΔX and ΔY) in an imaginary Cartesian coordinate system is respectively greater at least by a factor of 5, for example by a factor of 10, preferably by at least a factor of 20, more preferably by at least a factor of 30, than the height of the area section, said height being determined via the number of layers formed (extent in Z-direction: ΔZ). An area section for the purposes of the present invention can also be described as a preferably two-dimensional item which consists of from 1 to at most 200 layers or, in the case of a process of the invention in which a first layer comprising lines that do not contact one another and preferably run parallel to one another, from 2 to at most 200 layers. The expression “from 2 to at most 200 layers” refers in the case of an area section for the purposes of the present invention to the location of the area section with the maximal number of layers applied in a process of the invention orthogonally with respect to the operating plane (mutually superposed layers). In other words, at no location of an area section produced by a process of the invention are more than 200 layers applied on top of one another in a process of the invention; however, it is also possible by way of example that at other locations fewer layers are applied on top of one another.

In a preferred embodiment, the number of layers forming the two-dimensional area section is in the range from 2 to 200, preferably in the range from 2 to 150, more preferably in the range from 2 to 100, still more preferably in the range from 2 to 50.

In another preferred embodiment, the number of the layers is one (1), where this layer is a two-dimensional layer with or without cutouts.

It is preferable that the height of an area section (orthogonal extent of the area section with respect to the direction of a layer (Z-axis), which is proportional to the number of the mutually superposed layers) is at most 10 cm more preferably at most 3 cm, more preferably at most 1 cm, still more preferably at most 0.5 cm. It is preferable that the minimal height of an area section is 0.025 mm, more preferably 0.1 mm, still more preferably 0.2 mm, for example 0.5 mm. In the case of a corset, it is preferable that the thickness of the area section is preferably in the range from 0.5 to 1.5 cm.

It is preferable that an area section produced by a process of the invention consists of from 1 to 200 layers, preferably from 2 to 150 layers, where the thickness (height) of each layer is mutually independently in the range from 0.025 to 1.25 mm, more preferably in the range from 0.1 to 0.9 mm.

In a preferred embodiment, the area of an area section produced by a process of the invention is at least 5 cm², preferably at least 10 cm², more preferably at least 25 cm², for example at least 40 cm², at least 50 cm² or at least 100 cm², but the maximal orthogonal dimensions in the operating plane are respectively greater than the maximal deviation in the Z-plane at least by a factor of 5, preferably by a factor of 10, with preference by a factor of 20, with more preference by a factor of 30, with still more preference by a factor of 50.

By way of example, cellphone shells are currently deep-drawn from a thermoplastic film. The current process based on a film with uniform thickness has the disadvantage that the lateral areas and curved edges become very thin. However, mechanical wear is greatest specifically on the lateral areas and on the edges, and those regions are therefore frequently subject to mechanical failure (fracture). A 3D-printed film can have a topography such that more material is printed on the subsequent lateral areas and subsequent edges. By virtue of the process of the invention it is moreover also possible to realize specific reinforcement along directions of tensile force, either by applying more material or by printing different materials with different modulus of elasticity.

In a preferred embodiment, an area section has at least one layer consisting of mutually parallel lines of material or of a continuous area. In the case of layers consisting of a continuous area, the line density of the lines of material is 100%. In the case of a layer consisting of lines of material parallel to one another, the line density is generally in the range from 0.1% (distance between two lines 1000 times the thickness of a line of material) to 100% (continuous area with no distance between the applied lines of material), particularly preferably from 1% to 100%, for example from 10% to 100%.

### Hardening Procedure

After application of at least one layer in a process of the invention and optionally after application of further layers for the production of an area section for the purposes of the present invention, a substance mixture can by way of example be hardened via low- or high-temperature polymerization or, respectively, polyaddition or polycondensation, an addition reaction (e.g. PU addition reaction), or condensation, or else initiation by electromagnetic radiation, in particular UV radiation. Heat-curing plastics mixtures can be hardened by using an appropriate source of IR radiation.

Accordingly, a preferred embodiment is directed to a process in which the hardening of the two-dimensional area section is achieved by lowering the temperature of the lines of material below the temperature range of the melting range of a flowable and hardenable substance mixture (the application temperature by way of example in an FFF process is accordingly within or preferably above the melting range of the corresponding flowable and hardenable substance mixture).

Another preferred embodiment is directed to a process in which the hardening of the two-dimensional area section is achieved by using a UV-activatable hardener. Suitable UV-activatable hardeners here are by way of example products with trademark Irgacure from BASF which in accordance with their chemical composition initiate a curing reaction in suitable, often double-bond-bearing, compounds at various wavelengths via photochemical liberation of free radicals.

The prior are describes various two- or multicomponent systems which can be printed: by way of example, DE 19937770 A1 discloses a two-component system which comprises an isocyanate component and an isocyanate-reactive component. Droplet jets are produced from both components and are directed in such a way that they join to give a combined droplet jet. The reaction of the isocyanate component with the isocyanate-reactive component begins in the combined droplet jet. The combined droplet jet is guided onto a carrier material where it is used to construct a three-dimensional article with formation of a polymeric polyurethane.

An area section can be released from the flat base plate. This can be achieved entirely prior to a molding procedure, or to some extent as part of the process of molding of the three-dimensional object. If the intension is that there be an interlay between a flat base plate and a first layer in a process of the invention, the expression “release of the hardened area section from the flat base plate” refers to the release of the area section together with the interlay (for example a textile or a film) from the flat base plate.

Three-Dimensional Object with External Area Comprising at Least One Area Section Produced by the Process Described Herein

A three-dimensional object for the purposes of the present invention can be a cellphone shell, a housing, e.g. of an electrical product which has 3D structuring, a package or an item of furniture with surface structure, an A, B or C column, a roof module or a dashboard of an automobile, a seat shell, a filter basket, a medical product such as a rigid corset or orthosis, a protector, a damping element or a lightweight structure with framework structure, etc.

In a preferred embodiment, a three-dimensional object is a shell made of plastic, e.g. a cellphone shell.

In another preferred embodiment, a three-dimensional object is a curved object, e.g. designed for the shoulder region or upper arm region, preferably an individually designed protector, e.g. for shoulder, upper arm or elbow, of the type used by way of example in motor cycle apparel, said object being produced by the process described herein.

### Molding

A three-dimensional object can be produced by deep-draw methods or thermoforming from a two-dimensional area section, as long as the conditions of this process (e.g. high temperature) do not cause any damage to the area section. The respective conditions for the implementation and deep-draw processes or thermoforming for the molding of the hardenable polymers or reactive resins used in the process of the invention, in particular thermoplastics, are known to the person skilled in the art or can be determined by such a person through routine experimentation.

In the case of thermoforming, the shaping is achieved via prescribed molds (a male mold and a female mold matched thereto), between which the item to be molded is clamped. For the purposes of the present invention it is essential that the planar area of the two-dimensional area section undergoes molding in the Z-axis that, during shaping, is orthogonal to the plane of the two-dimensional area section. Setting is achieved here by cooling of the, now three-dimensional, object. It is thus possible by way of example to produce a curved protector.

### Individualized Protector

One aspect of the invention provides a process for the production of a protector appropriately designed for a user comprising the steps of:
a) determination of the relevant body-region-geometry data of the user;
b) calculation to convert the 3D-body-geometry data for the production of an area section in accordance with steps I) to V) or i) to iii) in accordance with a process of the aspect one or two;
c) manufacture of a three-dimensional object in a process as claimed in any of claims 1 to 13, where step VI) or, respectively, step iv), the three-dimensional shaping, takes place via deep-draw or thermoforming in accordance with the body-region-geometry data of the user from step a).

The expressions body-region-geometry data and 3D-body-geometry data are used synonymously.

In step a), the three-dimensional body dimensions of the region of a user (e.g. upper arm, thigh, upper body, head, forearm, lower leg or respectively parts thereof) are measured, these being the regions to be protected by a protector. This can by way of example be achieved by use of a laser, or an impression can be taken of the user region to be protected, and the three-dimensional impression can by way of example be measured by a laser or by other methods known to the person skilled in the art.

The data can by way of example be stored in a computer and, in a step b), conversion calculations can be carried out on the three-dimensional structure in a manner such that an area section is produced in a process of the invention and then in accordance with the body-region-geometry dimensions of the user, is subjected to deep-draw or to thermoforming (c).

In step a), the body-region-geometry data can be measured for various configurations (e.g. relaxed muscles or tenses muscles, flexion/elongation). By use of readily available computer programs it is possible, in step c), to calculate the required shape of a protector such that, after application of a protector, it is still possible to execute all of the movements of a body region requiring protection. It is also readily possible to calculate the size of a protector in a manner that retains space for movement between protector and body region requiring protection, in order as far as readily possible to retain free movement of the body region.

The deep-draw process or thermoforming process that provides three-dimensional shaping can by way of example take place in a three-dimensional mold produced in accordance with the body-region-geometry data.

The invention is explained in more detail with reference to examples and FIGS. 1 to 12.

FIG. 1 shows a typical FFF process setup with a polymer/substance-mixture feed in the form of a polymer-wire spool 1, an extruder 2, and an outlet nozzle 3 with outlet diameter 4, where a liquefied substance mixture from the polymer-wire spool is applied in the form of line of material from the outlet nozzle 3 to a substrate. A plurality of lines of material are produced here on a substrate in the form of a flat base plate 5 in the form of single layer, and said lines can form a continuous area consisting of connected lines of material, or an area consisting of geometric shapes connected to one another, an example being a honeycomb structure. Specifically, FIG. 1 is a diagram of the manufacturing process for a two-dimensional area section on the flat base plate 5, where a first layer 6 and a second layer 7 have already been completed and a third layer 7′ is now being applied to the second layer 7.

FIG. 2 shows the flat base plate 5 with, projecting thereon, a Cartesian coordinate system with the axes X, Y and Z.

FIG. 3 depicts the application of lines of material for a first layer of material on the flat base plate 5 by means of an outlet nozzle in the form of a jet nozzle 3. The first layer 6 is composed of individual lines 6₁ to 6₈ of material.

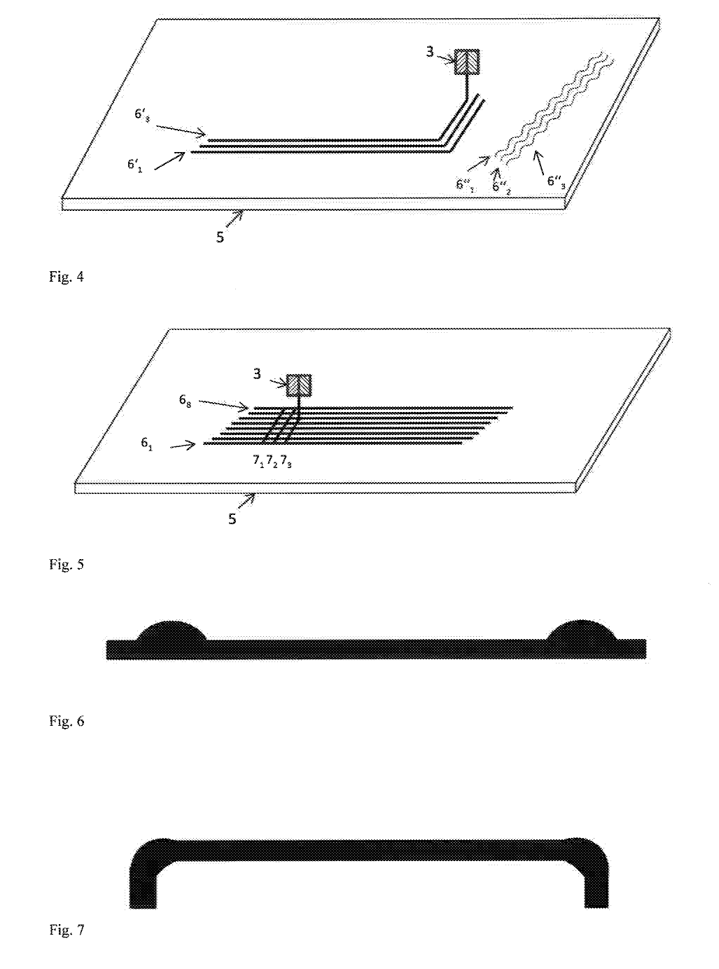

FIG. 4 shows, on the flat base plate 5 by means of the jet nozzle 3, lines of material applied and running parallel to one another for a first plane 6′ which exhibit a change of direction, and lines of material running parallel to one another for a first plane 6″ which have been applied in serpentine lines.

FIG. 5 is a diagram of the application of a second layer 7 onto a first layer 6, where the lines 7₁ to 7₃ of material of the second layer 7 are applied to the first layer 6 at an angle of 80° to the direction of application of the lines 6₁ to 6₈ of material of the first layer 6.

FIG. 6 shows a cross section of a hardened area section for the production of a cellphone shell.

FIG. 7 shows a cross section of a cellphone shell produced by thermoforming of the hardened area section of FIG. 6.

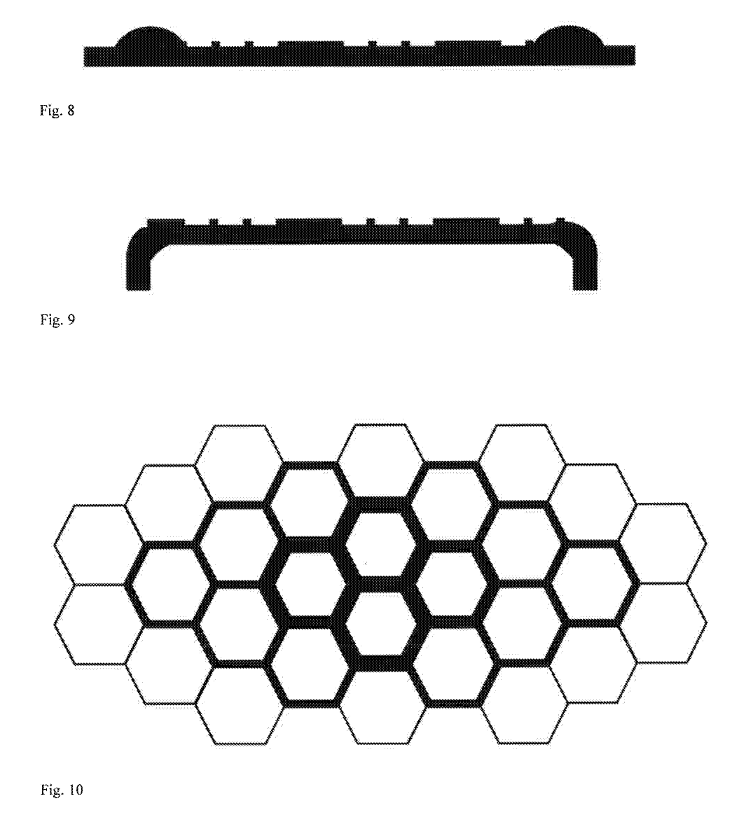

FIG. 8 shows a cross section of a hardened area section for the production of a cellphone shell with surface structure.

FIG. 9 shows a cross section of a cellphone shell produced by thermoforming of the hardened area section of FIG. 8, with surface structure.

FIG. 10 shows a plan view of an area section made of hexagonal layers for the production of a protector.

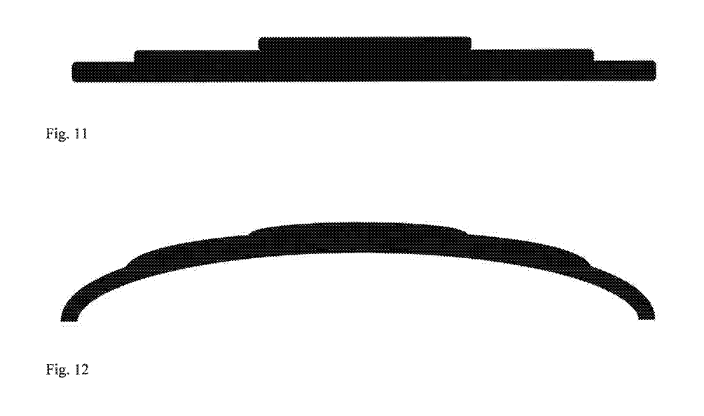

FIG. 11 shows a cross section of the hardened area section of FIG. 10.

FIG. 12 shows a cross section of a protector produced by thermoforming of the hardened area section of FIGS. 10 and 11.

The following parameter ranges are preferred parameter ranges for the production of a two-dimensional area section of the invention by means of FFF:

Temperature of base plate: in the range from 20° C. to 250° C., in particular from 60° C. to 200° C., e.g. 80° C.

Temperature of nozzle: in the range from 120° C. to 400° C.
Traverse velocity: in the range from 1 mm/s to 60 mm/s
Filament diameter: in the range from 1.5 mm to 3.5 mm
Nozzle diameter: in the range from 0.3 mm to 1 mm
Layer thickness: in the range from 0.1 mm to 0.9 mm (height less than nozzle diameter because distance between nozzle and uppermost layer is less than nozzle diameter, and therefore material is compressed to give strand with oval cross section)
Line width: dependent on nozzle in the range from 0.3 mm to 1 mm

1.-17. (canceled)

18. A process for the production of a three-dimensional object, the external area of which comprises at least one area section which is produced in that an area section in two-dimensional form is first produced by means of an additive manufacturing process (layer-by-layer shaping process) on a flat base plate, comprising the following steps:
I) applying at least one hardenable polymer or hardenable reactive resin in flowable form in the form of lines of material onto a flat base plate by means of a layer-by-layer shaping process for the production of a first layer;
II) applying a second layer onto the first layer, produced by means of a layer-by-layer shaping process;
III) optionally applying from 1 to 198 further layers produced as in step II), where respectively a new layer is applied onto the respective preceding layer;
IV) hardening of the layers;
V) separating the hardened area section from the flat base plate; and
VI) molding the hardened area section to give a three-dimensional object by means of deep-draw or thermoforming;
where at least one layer is produced via application of at least one hardenable polymer or hardenable reactive resin in flowable form in the form of lines of material onto the respective substrate with respectively a modulus of elasticity in the cured state of ≥500 MPa in accordance with EN ISO 527-1 (latest issue dated April 1996, current ISO version of February 2012).

19. A process for the production of a three-dimensional object, the external area of which comprises at least one area section which is produced in that an area section in two-dimensional form is first produced by means of an additive manufacturing process (layer-by-layer shaping process) on a flat base plate, comprising the following steps:
i) applying at least one hardenable polymer or hardenable reactive resin with respectively a modulus of elasticity in the cured state of ≥500 MPa in flowable form in the form of lines of material onto a flat base plate by means of a layer-by-layer shaping process for the production of a layer, where the layer provides a coherent area with or without cutouts;
ii) hardening of the layer;
iii) separating the hardened area section from the flat base plate; and
iv) molding of the hardened area section to give a three-dimensional object by means of deep-draw or thermoforming.

20. The process as claimed in claim 18, characterized in that a layer-by-layer shaping process is selected mutually independently from a group consisting of melt layering, fused filament fabrication, inkjet printing and photopolymer jetting.

21. The process as claimed in claim 18, where the lines of material are applied in the form of droplets onto the flat base plate or onto one of the layers that may already be present on the base plate.

22. The process as claimed in claim 18, characterized in that the discharge temperature of the substance mixtures from the nozzle in the steps I) to III) is in the range from 80° C. to 420° C.

23. The process as claimed in claim 18, characterized in that base plate has been heated and the heating temperature of the base plate is in the range from 20° C. to 250° C.

24. The process as claimed in claim 18, characterized in that a hardenable polymer or hardenable reactive resin with respectively a modulus of elasticity in the cured state of ≥500 MPa is selected from the group consisting of thermoplastic polyurethane, polycarbonate, polyamide, polyethylene terephthalate, polybutylene terephthalate, cycloolefinic copolyester, polyetheretherketone, polyetheramideketone, polyetherimide, polyimide, polypropylene, polyethylene, acrylonitrile-butadiene-styrene, polylactate, polymethyl, methacrylate, polystyrene, polyvinyl chloride, polyoxymethylene, polyacrylonitrile, polyacrylate, and celluloid.

25. The process as claimed in claim 18, characterized in that the same hardenable polymer or hardenable reactive resin is used in all of the layers.

26. The process as claimed in claim 18, characterized in that at least one layer comprises another hardenable polymer and hardenable reactive resin.

27. The process as claimed in claim 18, characterized in that a hardenable polymer or hardenable reactive resin with respectively a modulus of elasticity in the cured state of ≥500 MPa is used in all of the layers.

28. The process as claimed in claim 18, characterized in that a hardenable polymer or hardenable reactive resin with respectively a modulus of elasticity in the cured state of <500 MPa is used in at least one layer.

29. The process as claimed in claim 28, characterized in that a hardenable polymer or hardenable reactive resin with respectively a modulus of elasticity in the cured state of <500 MPa is used in the first layer.

30. The process as claimed in claim 28, characterized in that a hardenable polymer or hardenable reactive resin with respectively a modulus of elasticity in the cured state of <500 MPa is used in the final layer.

31. The process as claimed in claim 18, characterized in that the three-dimensional object is a cellphone shell, a housing, where said item has a 3D profile, packaging or an item of furniture with surface structures, an A, B or C column, a roof module or a dashboard of an automobile, a seat shell, a filter basket, a medical product such as a rigid corset or an orthosis, a protector, a damping element or a lightweight structure with framework structure.

32. The process as claimed in claim 18, where the first layer is applied to an interlay, for example a textile or a foil, which transfers the surface shape of the flat base plate to the first layer of a process of the invention, and to which the lines of material of the first layer bond, so that this interlay becomes part of the area section and thus also part of the three-dimensional object.

33. A process for the production of a protector designed appropriately for a user, comprising the steps of:
a) determining the relevant body-region-geometry data of the user;
b) calculating to convert the 3D-body-geometry data for the production of an area section;
c) manufacturing a three-dimensional object in a process as claimed in claim 18, where step VI) or, respectively, step iv), the three-dimensional shaping, takes place via deep-draw or thermoforming in accordance with the body-region-geometry data of the user from step a).

34. A protector obtained by the process as claimed in claim 18.
